(19) United States
(12) Patent Application Publication
(10) Pub. No.: US 2026/0227654 A1
(43) Pub. Date: Aug. 6, 2026

(54) MULTI-COLOR LIGHT-DIFFUSER DEVICES

(71) Applicant: Adobe Inc., San Jose, CA (US)

(72) Inventors: Tenell RHODES, San Jose, CA (US); Gavin Stuart Peter MILLER, Los Altos, CA (US)

(73) Assignee: Adobe Inc., San Jose, CA (US)

(21) Appl. No.: 19/045,419

(22) Filed: Feb. 4, 2025

(51) Int. Cl. G02F 1/1334; G02F 1/1335

(52) U.S. Cl. CPC G02F 1/13342; G02F 1/133504; G02F 1/133514

(57) ABSTRACT

Embodiments are disclosed for multi-color light-diffuser devices capable of displaying different colors based on stack configurations of polymer dispersed liquid crystal (PDLC) diffuser components, base layers, and filter layers. In one embodiment, a multi-color light-diffuser device can include a base layer positioned underneath a filter layer and a PDLC diffuser component positioned above the filter layer. In another embodiment, a multi-color light-diffuser can include an additional PDLC diffuser component in between the base layer and filter layer. The filter layer can be a dichroic material, a neutral density filter, or other transparent or semi-transparent material. The base layer can be an opaque material, such as paper, holographic film, iridescent film, or a mirror. Based on the activation of the light-scattering or non-light-scattering states of the PDLC diffuser components, the multi-color light-diffuser device can express different visual outputs based on the interactions/mixing of the filter layer and base layer.

### BACKGROUND

There has been increased development in the area of incorporating electronic devices into portable objects (e.g., wearable electronics) and large format displays (e.g., wall displays). For instance, incorporating light emitting diodes (LEDs) into fashion (e.g., textiles, clothing, garments, and fashion accessories) to show patterns, designs, and displays are increasing in use and popularity. Other examples of incorporating wearable electronics into fashion include electronic-ink and electronic paper devices.

### SUMMARY

Introduced here are techniques/technologies that allow for multi-color light-diffuser devices that are formed by layering one or more polymer dispersed liquid crystal (PDLC) diffuser component with color filters and/or base layers. Through varying arrangements of these components and through the activation or non-activation of the PDLC diffuser component(s), multiple colors can be expressed through the multi-color light-diffuser devices.

In particular, in one or more embodiments, a multi-color light-diffuser device can be arranged, from top to bottom, with a PDLC diffuser component, a filter layer, another PDLC diffuser component, and a base layer. Based on the activation or non-activation of one or both of the PDLC diffuser components, the multi-color light-diffuser device can express three different colors, or states, based on the interactions/mixing of the colors of the filter layer and the base layer and the states of the PDLC diffuser components. In other embodiments, bicolor light-diffuser devices can be formed through different arrangements of a PDLC diffuser component, a color/pattern filter layer, and a base layer. For example, a bicolor light-diffuser device with an arrangement, from top to bottom, of a filter layer, PDLC diffuser component, and a base layer can express two contrasting colors or states (e.g., based on the interactions/mixing of the filter layer and the base layer and the state of the PDLC diffuser component). The colors displayed by the multi-color light-diffuser devices can be influenced by the materials used for the filter layer and the base layer. In one or more embodiments, the material for the base layer can include one or more of: a dichroic material (e.g., film, glass, etc.), white paper, black toner printed on white paper, black toner printed on black paper, a neutral density filter, shiny paper (e.g., wrapping paper), foil paper, holographic film, iridescent film, a mirror or mirror film, a polarized filter, a polarized filter stacked with a cross-polarized filter, and any other opaque or semi-opaque materials. In one or more embodiments, the material for the filter layer can include one or more of a dichroic material, a neutral density filter, holographic film, iridescent film, a polarized filter, a pair of cross-polarized filters, and any other transparent or semi-transparent materials.

In some embodiments, multiple light-diffuser devices with multi-color capabilities can be arranged into various designs and shapes. For example, a plurality of light-diffuser devices can be arranged into a multi-color mosaic design or grouped as sub-pixels to create a full color display through color mixing. Additional details regarding light-diffuser devices can be found in U.S. Pat. No. 10,935,861, which is hereby incorporated by reference.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying drawings in which:

FIGS. 1A-1B illustrate example layers of a polymer dispersed liquid crystal (PDLC) diffuser component 100 associated with a light-diffuser device in accordance with one or more embodiments;

FIGS. 1C-1D illustrate examples of the PDLC diffuser component 100 in accordance with one or more embodiments;

FIG. 2 illustrates a schematic of a light-diffuser device in accordance with one or more embodiments;

FIG. 3 illustrates details of exemplary bicolor PDLC diffuser structures in accordance with one or more embodiments;

FIG. 4 illustrates details of exemplary bicolor PDLC diffuser structures in accordance with one or more embodiments;

FIG. 5 illustrates details of exemplary bicolor PDLC diffuser structures in accordance with one or more embodiments;

FIG. 6 illustrates details of exemplary bicolor PDLC diffuser structures using dichroic film layers in accordance with one or more embodiments;

FIG. 7 illustrates details of exemplary bicolor PDLC diffuser structures using color filters in accordance with one or more embodiments;

FIG. 8 illustrates details of exemplary bicolor PDLC diffuser structures in accordance with one or more embodiments;

FIG. 9 illustrates details of exemplary tricolor PDLC diffuser structures in accordance with one or more embodiments;

FIG. 10 illustrates details of exemplary tricolor PDLC diffuser structures in accordance with one or more embodiments;

FIG. 11 illustrates details of resulting PDLC diffuser structures under different layer combinations in accordance with one or more embodiments;

FIG. 12 illustrates a flowchart of a series of acts in a method of causing the display of multiple colors on a light-diffuser device based on the activation of PDLC diffuser components included in the light-diffuser device;

FIG. 13 illustrates a flowchart of a series of acts in a method of causing the display of multiple colors on a light-diffuser device based on the activation of a polymer dispersed liquid crystal (PDLC) diffuser component included in the light-diffuser device; and

FIG. 14 illustrates a block diagram of an exemplary computing device in accordance with one or more embodiments.

### DETAILED DESCRIPTION

One or more embodiments of the present disclosure include light-diffuser devices that can produce multiple color states based on the activation or non-activation of polymer dispersed liquid crystal (PDLC) diffuser, or light-diffuser, components. When activated, some PDLC diffuser components become transparent or clear, allowing colors, patterns, etc., disposed beneath the PDLC diffuser components to be more visible. Non-activated PDLC diffuser components become opaque or milky-white, reducing the amount of any colors, patterns, etc., disposed beneath the PDLC diffuser components to be more visible. Although in the embodiments described herein, the PDLC diffuser components are described as operating in this manner, other variations of PDLC diffuser components can operate in different ways. For example, some PDLC diffuser components operate in the opposite manner (e.g., opaque when activated and transparent when not activated).

Existing techniques for incorporating electronic devices into objects (e.g., clothing, fashion accessories, or large format displays) include light-emitting diodes (LEDs), projection mapping, and electronic-ink (e-ink). However, LEDs can require relatively large power sources, projection mapping is lighting dependent, and e-ink does not support video refresh rates or large-scale integration. Some existing techniques also require relatively high voltages, which can be unsafe and potentially dangerous to users if they are to come in contact with them, which is problematic for wearable electronics. Further, both LEDs and projection mapping are emissive technologies that can create significantly more light pollution for many installations. Another existing technology is a paper-like display device that is capable of the video refresh rates but does not support color.

To address these and other deficiencies in conventional systems, light-diffuser devices can include one or more PDLC diffuser components and one or more base layers arranged into PDLC diffuser structures that can express multiple colors based on the activation and/or non-activation, or deactivation, of the PDLC diffuser components. The light-diffuser devices that incorporate PDLC diffuser components can provide a flexible, safe, durable, portable, inexpensive, and visually rich solution to problems facing conventional wearable electronics. For example, the PDLC diffuser components require relatively less power, less voltage, and are non-emissive.

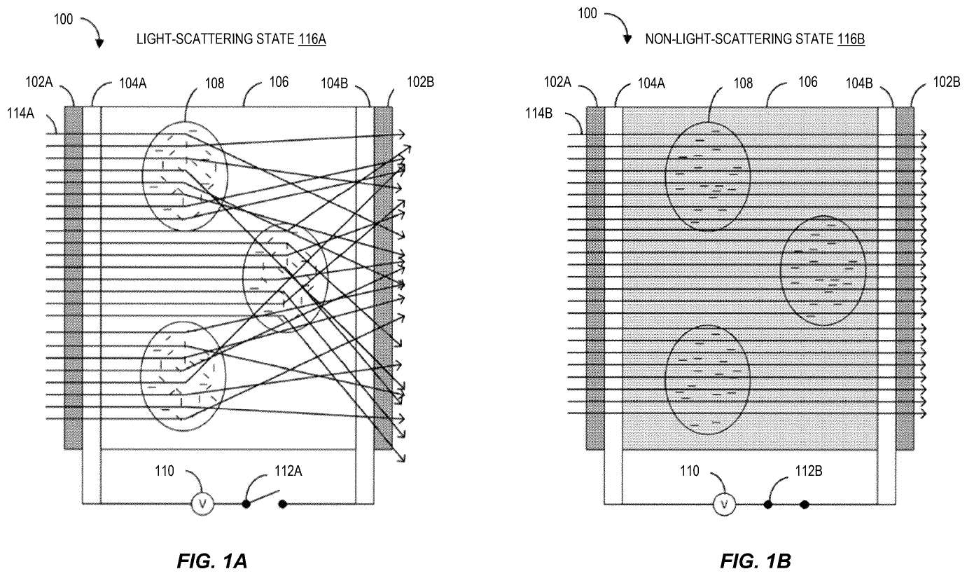

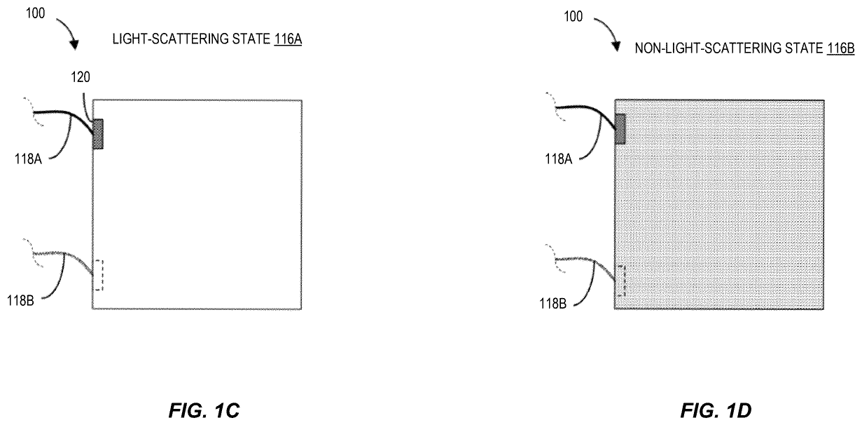

FIGS. 1A-1B illustrate example layers of a polymer dispersed liquid crystal (PDLC) diffuser component 100 associated with a light-diffuser device in accordance with one or more embodiments. In one or more embodiments, the light-diffuser devices can be modular light-diffuser devices. As shown, the PDLC diffuser component 100 includes polyethylene terephthalate (PET) film layers 102A and 102B. The PDLC diffuser component 100 also includes first conductive coating layer 104A and second conductive coating layer 104B. Further, the PDLC diffuser component 100 includes a polymer layer 106 having dispersed liquid crystal molecules 108 (collectively called a “PDLC film layer” or “PDLC film”).

In one or more embodiments, the PET film layers 102A and 102B serve as transparent boundaries that protect the inner layers of the PDLC diffuser component 100. The first conductive coating layer 104A and the second conductive coating layer 104B include transparent material that enables current to freely flow through it. In some embodiments, the first conductive coating layer 104A and the second conductive coating layer 104B include indium tin oxide (ITO). In some embodiments, the polymer layer 106 starts as a liquid that is infused with droplets of liquid crystal molecules 108, then cures into a solid material, holding in the liquid crystal molecules 108.

For purposes of explanation, FIGS. 1A-1B include a power source 110 (e.g., capable of providing both positive voltage and connection to ground) coupled to a switch. When the switch is in an open state 112A, voltage is not applied to the PDLC diffuser component 100. As a result, the liquid crystal molecules 108 within the polymer layer 106 are randomly oriented and deflect (i.e., scatter) light rays 114A that attempt to pass through the PDLC diffuser component 100. When the PDLC diffuser component 100 is in a light-scattering state 116A, the PDLC diffuser component 100 can appear milky-white and diffuse.

When the switch is in the closed state 112B, current from the applied voltage of the power source 110 flows into the first conductive coating layer 104A, through the polymer layer 106, into the second conductive coating layer 104B, and back to the power source 110. As a result of voltage being applied, the liquid crystal molecules 108 align in an organized manner to let light rays 114B pass through. When the PDLC diffuser component 100 is in a non-light-scattering state 116B, the PDLC diffuser component 100 can appear transparent, clear, or see through.

In many embodiments, the PDLC diffuser component 100 passively allows light to pass through it when in the non-light-scattering state 116B. In particular, when the PDLC diffuser component 100 is in the non-light-scattering state 116B, light from outside passes through the transparent PDLC diffuser component 100, reflects off of the material behind the PDLC diffuser component 100 (e.g., clothing, fabric, a mirror), and then passes back through the transparent PDLC diffuser component 100. In general, passive components require less power, and thus, can be safer for users to wear and use. However, in some embodiments, the PDLC diffuser component 100 can include additional layers that provide light (e.g., active components), which can range from a faint glow to a bright light, depending on the type of layer and the amount of power supplied.

In one or more embodiments, the power source 110 and/or switch are provided via the light-diffuser device and/or light-diffuser system. For example, as described below, the light-diffuser device configures power to flow multiple directions through the PDLC diffuser component 100. Further, switches (e.g., analog switches or logic switches) controlled by a light-diffuser system can control the flow of power to the light-diffuser system, and thus, the state of the PDLC diffuser component 100.

As mentioned above, the PDLC diffuser component 100 can be small in size and made of flexible, inexpensive material. In such embodiments, despite the PDLC diffuser component 100 including multiple layers, the PDLC diffuser component 100 can easily flex, bend, and move comparable to a thin piece of plastic. In this manner, when added to clothing, the PDLC diffuser component 100 can be worn without noticeably impeding the mobility of the user. Due to their flexibility, when added to clothing, the PDLC diffuser component 100 can be nonrestrictive and comfortable to wear.

While a particular arrangement of layers is shown, in some embodiments, the PDLC diffuser component 100 can include additional, fewer, or different layers. For instance, one or both of the PET film layers 102A, 102B can be replaced with glass or another material. In addition, layers of the PDLC diffuser component 100 can be modified to create different light-scattering/transparency effects. For example, in one or more embodiments, the first PET film layer 102A can be divided into separate segments (e.g., cut into stripes). Further, each segment can be activated individually, creating a striped effect as the power is pulled down across the film layer (e.g., creating a “bar graph” effect).

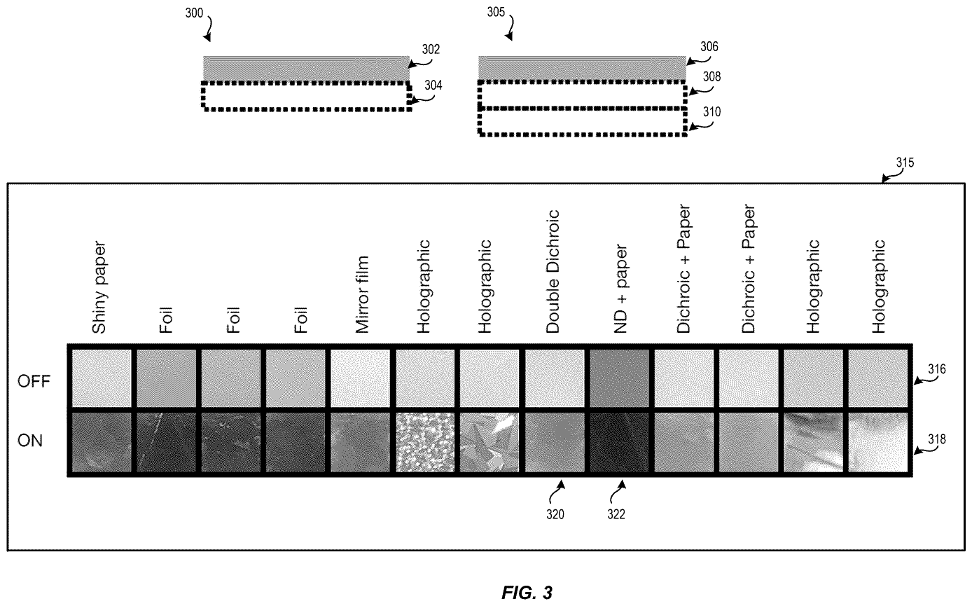

FIGS. 1C-1D illustrate examples of the PDLC diffuser component 100 in accordance with one or more embodiments. In particular, FIG. 1C shows the PDLC diffuser component 100 in a light-scattering state 116A. FIG. 1D shows the PDLC diffuser component 100 in a non-light-scattering state 116B. As shown, when in the light-scattering state 116A, the PDLC diffuser component 100 can appear white and diffuse. On the other hand, when in the non-light-scattering state, the PDLC diffuser component 100 can appear transparent. In one or more embodiments, a base layer is positioned under the PDLC diffuser component 100. In one or more embodiments, the base layer can be a color filter of different material types (e.g., plastic, glass, paper, wood, etc.), a mirror or other reflective base layer, or other similar objects. For example, in one or more embodiments, a color filter is positioned under the PDLC diffuser component 100. In such embodiments, when in the non-light-scattering state, the PDLC diffuser component 100 can appear the color of the color filter. In another example, in one or more embodiments, a mirror is positioned under the PDLC diffuser component 100. In such embodiments, when in the non-light-scattering state, the PDLC diffuser component 100 can appear silver. As described in further detail in FIGS. 3-8, different layering combinations of one or more PDLC diffuser components 100, color filters, and base color layers can produce multiple colors depending on the states of the one or more PDLC diffuser components 100.

As shown in FIGS. 1C-1D, the PDLC diffuser component 100 can include conductive elements 118A and 118B (e.g., traces, copper tape, conductive thread, wires, or other conductive material) that connect to the PDLC diffuser component 100. For example, the conductive elements 118A and 118B connect to the first conductive coating layer 104A and the second conductive coating layer 104B of the PDLC diffuser component 100, respectively. Accordingly, the conductive elements 118A and 118B can provide power to the PDLC diffuser component 100 from a power source 110, as described above. In addition, in one or more embodiments, the conductive elements 118A and 118B can connect to the first conductive coating layer 104A and the second conductive coating layer 104B via a bus bar 120.

As mentioned above, the PDLC diffuser component 100 can be connected to a corresponding light-diffuser device. In general, there is a one-to-one ratio between light-diffuser devices and PDLC diffuser components 100. As such, each light-diffuser device provides power to a PDLC diffuser component 100 causing it to change states. As also mentioned above, light-diffuser devices can receive power from switches. In general, the number of switches is far fewer than the number of light-diffuser devices.

While the PDLC diffuser components 100 are visible when attached to an object, the corresponding light-diffuser devices, switches, controllers, power source, and/or other components can be hidden. For example, when PDLC diffuser components 100 are attached to a shirt, each light-diffuser device can be hidden below or adjacent to its corresponding PDLC diffuser component 100. In some embodiments, the light-diffuser device for a PDLC diffuser component 100 can be located near the seam of a garment or in the bezel of an accessory (e.g., in a compact regular or flexible PCB). Similarly, the switches and other components can be hidden away from the PDLC diffuser components 100 on or within the shirt.

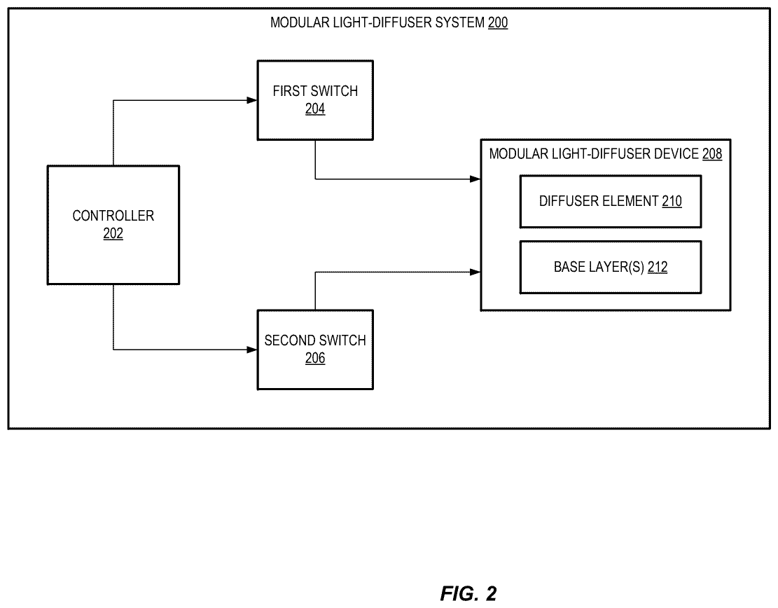

FIG. 2 illustrates a schematic of a light-diffuser device in accordance with one or more embodiments. As shown, FIG. 2 illustrates the light-diffuser device 208 having a diffuser element 210 and at least one base layer 212. In one or more embodiments, the diffuser element 210 comprises a PDLC diffuser component having a PDLC diffuser film layer, as described above. In one or more embodiments, the base layer 212 can have a color, a texture, etc. In one or more embodiments, there can be a gap between the diffuser element 210 and the base layer 212. In one or more embodiments, the base layer 212 is opaque. In one or more embodiments, the material for the base layer 212 can include one or more of: a dichroic material (e.g., film, glass, etc.), white paper, black toner printed on white paper, black toner printed on black paper, a neutral density filter, shiny paper (e.g., wrapping paper), foil paper, holographic film, iridescent film, a mirror or mirror film, a polarized filter, a polarized filter stacked with a cross-polarized filter, and any other opaque or semi-opaque materials. As also shown, the light-diffuser device 208 is connected to a first switch 204 and a second switch 206, which are managed by a controller 202 (e.g., a microcontroller). While analog switches are shown that operate at 15 volts or higher, in one or more embodiments, digital logic switched can be utilized instead when the low-voltage power source is approximately 5 volts.

In various embodiments, the controller 202, the first switch 204, the second switch 206, and the light-diffuser device 208 are part of a light-diffuser system 200. For instance, the light-diffuser system 200 can change the state of the diffuser element 210 (e.g., between the light-scattering state and the non-light-scattering state) as well as provide generated alternating current to the diffuser element 210 based on sending signals to the analog switches via the controller 202. By changing the state of the diffuser element 210, the light-diffuser device 208 can display different colors and/or textures. In some embodiments, the light-diffuser system includes additional analog switches and light-diffuser devices (e.g., a grid of light-diffuser devices controlled by switches).

In some embodiments, the controller 202 can provide a control signal to the analog switches to indicate when each switch should provide power to the light-diffuser device 208. In addition, the controller 202 can provide a synchronization clock to synchronize the switches with each other. For example, the controller can utilize a Serial Peripheral Interface (SPI) to provide input signals, power, clock signals, and other signals to the analog switches. In various embodiments, the controller 202 is a microprocessor having memory (e.g., RAM) and programmed instructions (e.g., in hardware or software) to manage the light-diffuser system 200.

Moreover, when activating the non-light-scattering state, as mentioned above, driving generated alternating current across the diffuser element 210 can extend the life of the diffuser element 210. However, the light-diffuser system 200 utilizes a direct current power source (e.g., a direct current power battery). Accordingly, in one or more embodiments, the controller 202 can enable the light-diffuser device 208 to generate alternating current from a direct current power source at the diffuser element 210 utilizing the first switch 204 and the second switch 206.

To illustrate, the light-diffuser device 208 receives power via the first switch 204 and provides electrical current in a first direction across the diffuser element 210 (i.e., from top to bottom). The light-diffuser device 208 receives power via the second switch 206 and provides electrical current in a second, opposing direction across the diffuser element 210 (e.g., from bottom to top). In this manner, while the two switches can draw power from the same direct current power source, the controller 202 can utilize the switches 204 and 206 in a way that enables the light-diffuser device 208 to generate alternating current across the diffuser element 210, as if each switch is providing power from a separate inverted source.

More specifically, when activating the non-light-scattering state, the controller 202 provides a first instruction set that instructs the first switch 204 to provide voltage (e.g., 15 volts) to the light-diffuser device 208 as well as instructs the second switch 206 to provide ground (e.g., 0 volts) to the light-diffuser device 208. The controller 202 can also provide a second instructions set that instructs the second switch 206 to provide voltage and the first switch 204 to provide ground to the light-diffuser device 208.

Moreover, when activating the non-light-scattering state, the controller 202 can utilize a clock signal having a set frequency (e.g., 50 Hz) to determine when to alternate between the two switches. In one or more embodiments, the controller 202 can provide the first instruction set at a first time period (e.g., time interval) and the second instruction set at a second time period. The controller 202 can selectively provide instructions to the first switch 204 and the second switch 206 to continue alternating between the instructions sets to maintain the non-light-scattering state at the diffuser element 210. Then, the controller can instruct the switches 204 and 206 to stop providing power to transition the light-diffuser device 208 to the light-scattering state.

In additional embodiments, different voltage and/or frequency can be applied to the light-diffuser device 208 to allow the diffuser element 210 to partially transition between the light-scattering state and the non-light-scattering state, and vice versa. For example, if the diffuser element 210 becomes transparent at 15 volts, applying a higher voltage can achieve the same effect. However, applying a lower voltage, in some embodiments, causes the diffuser element 210 to become partially transparent. Thus, in these embodiments, the light-diffuser system 200 can utilize different lower voltages to achieve different grayscale or transparency levels for the diffuser element 210. Similarly, in various embodiments, the light-diffuser system can vary the grayscale or transparency levels of the diffuser element 210 by modulating the duty cycle (pulse width modulation, PWM) and/or the frequency (e.g., less than 50 Hz).

FIG. 3 illustrates details of exemplary bicolor PDLC diffuser structures in accordance with one or more embodiments. In one or more embodiments, bicolor PDLC diffuser structure stack configuration 300 includes a PDLC diffuser component 302 layered onto a base layer 304. While FIG. 3 illustrates bicolor PDLC diffuser structure stack configurations with one or two base layers, in alternative embodiments, there may be greater than two base layers. The base layer 304 can be any material (e.g., plastic, paper, wood, etc.). In one or more embodiment, where the base layer 304 is black paper, base layer 304 can be black paper, black ink or toner printed on white paper, black ink or toner printed on black paper, a neutral density filter, a polarized filter, and/or a polarized filter stacked with a cross-polarized filter. In one or more embodiments, bicolor PDLC diffuser structure stack configuration 305 includes a PDLC diffuser component 306 layered onto a filter layer 308 and a base layer 310. In some embodiments, filter layer 308 can be formed from a combination of multiple layers, where the multiple layers can include multiple types of materials. For example, filter layer 308 can be a combination of multiple dichroic film layers or multiple neutral density filters. In either example, the base layer 310 can be paper.

Diagram 315 illustrates a plurality of different base layers of bicolor PDLC diffuser structures in both a light-scattering state (e.g., white and diffuse) or a non-light-scattering state (e.g., transparent or clear). The examples include shiny paper, foil, mirror film, holographic film, double dichroic film, neutral density film and paper, and dichroic film and paper. In one or more embodiments, based on whether the PDLC diffuser component (e.g., PDLC diffuser component 302 or PDLC diffuser component 306) is in a light-scattering state or a non-light-scattering state, the resulting color displayed by the bicolor PDLC diffuser structure can be modified.

Using the example base layers described previously, row 316 illustrates the color displayed by the bicolor PDLC diffuser structures for each of the different base layers when the PDLC diffuser component is in a light-scattering state, while row 318 illustrates the color displayed by the bicolor PDLC diffuser structures for each of the different base layers when the PDLC diffuser component is in a non-light-scattering state. Example 320 illustrates the result of layering one PDLC diffuser component over two layers of dichroic film (e.g., magenta and cyan) over white paper. When the PDLC diffuser component is in light-scatting and non-light-scattering states, example 320 produces a white or purple color, respectively. Example 322 illustrates the result of layering one PDLC diffuser component over a neutral density filter over black paper. When the PDLC diffuser component is in light-scatting and non-light-scattering states, example 322 produces a gray or black color, respectively.

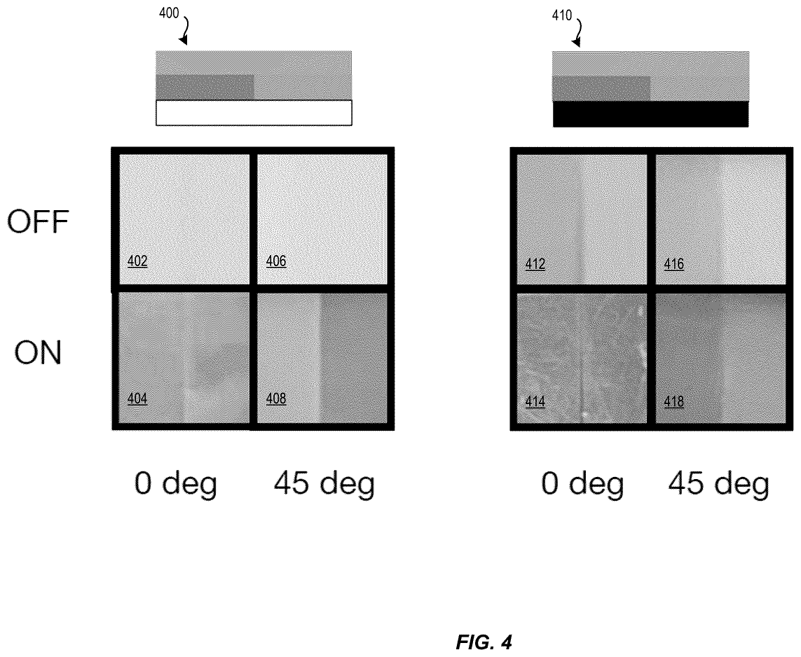

FIG. 4 illustrates details of exemplary bicolor PDLC diffuser structures in accordance with one or more embodiments. For example, bicolor PDLC diffuser structure stack configuration 400 includes, from top layer to bottom layer, a PDLC diffuser component, a filter layer (e.g., split between magenta and cyan), and a white base layer. In one or more embodiments, the material for the base layer can include one or more of: a dichroic material (e.g., film, glass, etc.), white paper, black toner printed on white paper, black toner printed on black paper, a neutral density filter, shiny paper (e.g., wrapping paper), foil paper, holographic film, iridescent film, a mirror or mirror film, a polarized filter, a polarized filter stacked with a cross-polarized filter, and any other opaque or semi-opaque materials. In one or more embodiments, the material for the filter layer can include one or more of a dichroic material, a neutral density filter, holographic film, iridescent film, a polarized filter, a pair of cross-polarized filters, and any other transparent or semi-transparent materials.

In the example of FIG. 4, the material of the filter layer is dichroic film. In one or more embodiments, when a PDLC diffuser component is introduced over dichroic films, the resulting bicolor PDLC diffuser structures can produce different results based on the base layer. Based on whether the PDLC diffuser component is in a light-scattering state or a non-light-scattering state, the bicolor PDLC diffuser structure stack configuration 400 can display different colors. For example, when the bicolor PDLC diffuser structure is viewed directly overhead at a zero degree angle, and the PDLC diffuser component is in a light-scattering state, white (or a close approximation) is produced (box 402). When the bicolor PDLC diffuser structure is viewed at a zero degree angle, and the PDLC diffuser component is in a non-light-scattering state, color corresponding to the dichroic film layers are produced (box 404). In one or more embodiments, when the bicolor PDLC diffuser structure is viewed at a 45-degree angle, and the PDLC diffuser component is in a light-scattering state, white (or a close approximation) is produced (box 406). When the bicolor PDLC diffuser structure is viewed at a 45-degree angle, and the PDLC diffuser component is in a non-light-scattering state, color corresponding to the dichroic film layers are produced (box 408).

Bicolor PDLC diffuser structure stack configuration 410 includes, from top layer to bottom layer, a PDLC diffuser component, dichroic film layer (e.g., split between magenta and cyan), and a black base layer. When the bicolor PDLC diffuser structure is viewed directly overhead at a zero degree angle, and the PDLC diffuser component is in a light-scattering state, the colors shown in box 412 are produced (e.g., blue where the magenta dichroic film is located and orange where the cyan dichroic film is located). When the bicolor PDLC diffuser structure is viewed at a zero degree angle, and the PDLC diffuser component is in a non-light-scattering state, the colors shown in box 414 are produced (e.g., green where the magenta dichroic film is located and red where the cyan dichroic film is located). In one or more embodiments, when the bicolor PDLC diffuser structure is viewed at a 45-degree angle, and the PDLC diffuser component is in a light-scattering state, the colors shown in box 416 are produced. When the bicolor PDLC diffuser structure is viewed at a 45-degree angle, and the PDLC diffuser component is in a non-light-scattering state, the colors shown in box 418 are produced.

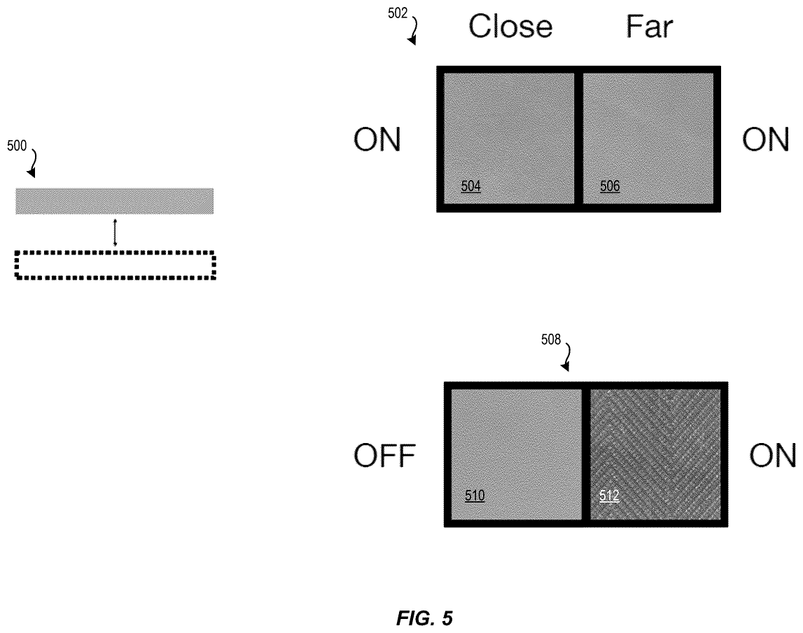

FIG. 5 illustrates details of exemplary bicolor PDLC diffuser structures in accordance with one or more embodiments. In one or more embodiments, bicolor PDLC diffuser structures can be configured with a gap between layers instead of the layers being in close or direct contact. In one or more embodiments, the gap is a physical separation between the layers, where air can pass through. In some embodiments, the size of the gap can be between 0.5 mm and 3 mm. In other embodiments, the size of the gap can be between within a different size range. For example, bicolor PDLC diffuser structure stack configuration 500 includes, from top layer to bottom layer, a PDLC diffuser component and a base layer, with a gap in between the two layers. In such embodiments, the size of the gap between the layers can result in changes to the displayed color of the bicolor PDLC diffuser structure. In bicolor PDLC diffuser structure 502, a holographic film base layer is placed under a PDLC diffuser component. When the two layers are “close” (e.g., little or no gap) and the PDLC diffuser component is in a non-light-scattering state, the color shown in box 504 is produced. When the two layers are “far” from each other (e.g., a gap is placed between the two layers) and the PDLC diffuser component is in a non-light-scattering state, the color shown in box 506 is produced. In such embodiments, increasing the distance between the PDLC diffuser component and the holographic film layer allows for the colors of the holographic film to be seen without a direct light source. When the PDLC diffuser component and the holographic film layer are in direct contact or close, the PDLC diffuser component attenuates the light, preventing the colors of the holographic film from being seen in ambient lighting conditions.

In one or more embodiments, the base layer can include a texture or pattern. For example, bicolor PDLC diffuser structure 508 includes a base layer with a metal mesh-like texture suspended in glass placed under a PDLC diffuser component. When there is a gap between the two layers (e.g., metal mesh-like texture suspended in glass), and the PDLC diffuser component is in a light-scattering state, the color shown in box 510 is produced, where the pattern/texture of the base layer is not visible. When there is a gap between the two layers, and the PDLC diffuser component is in a non-light-scattering state, the pattern/texture of the base layer is visible, as shown in box 512. When the PDLC diffuser component and the base layer (e.g., metal mesh-like texture without being suspended in glass) are in direct contact or “close,” and the PDLC diffuser component is in a light-scattering state, the pattern/texture of the base layer is visible through the PDLC diffuser component.

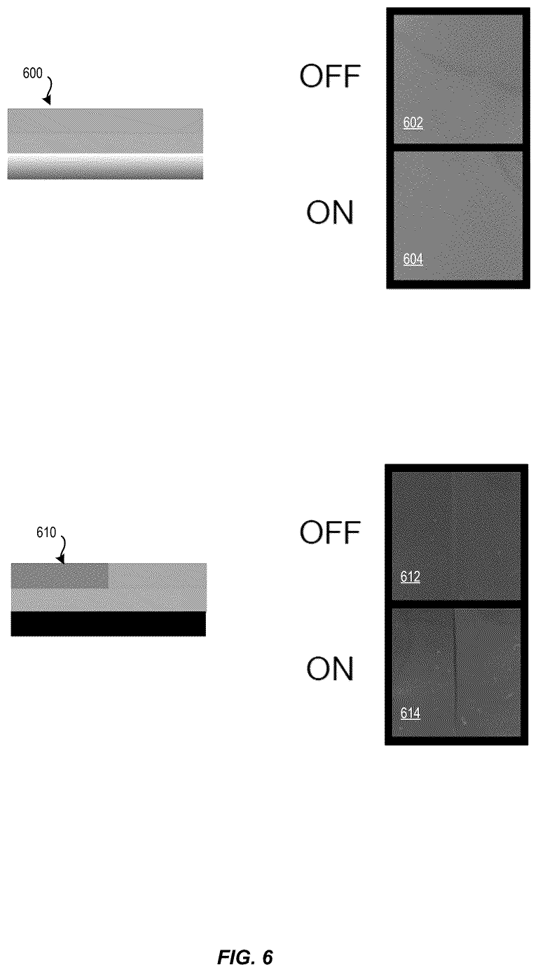

FIG. 6 illustrates details of exemplary bicolor PDLC diffuser structures using dichroic film layers in accordance with one or more embodiments. The examples in FIG. 6 depict the results of placing a PDLC diffuser component between dichroic film and another material of varying types. For example, bicolor PDLC diffuser structure stack configuration 600 includes, from top layer to bottom layer, a dichroic film layer (e.g., cyan), a PDLC diffuser component, and a mirror base layer. When the PDLC diffuser component of the bicolor PDLC diffuser structure stack configuration 600 is in a light-scattering state, the color shown in box 602 is produced. When the PDLC diffuser component of the bicolor PDLC diffuser structure stack configuration 600 is in a non-light-scattering state, the color of the cyan dichroic film layer is not visible and only the reflective surface of the mirror base layer is seen, as shown in box 604. Thus, when dichroic films are placed over a mirror base layer, the dichroic film appears transparent when a PDLC diffuser component between the two layers is in a non-light-scattering state and the color of the bicolor PDLC diffuser structure will be based on the reflective surface of the mirror layer, the environment where the bicolor PDLC diffuser structure is located (e.g., lighting, objects, etc.), and/or an angle of the bicolor PDLC diffuser structure.

In another example, bicolor PDLC diffuser structure stack configuration 610 includes, from top layer to bottom layer, a dichroic film layer (e.g., split between magenta and cyan), a PDLC diffuser component, and a black base layer. When the PDLC diffuser component of the bicolor PDLC diffuser structure stack configuration 610 is in a light-scattering state, the colors shown in box 612 are produced. When the PDLC diffuser component of the bicolor PDLC diffuser structure stack configuration 610 is in a non-light-scattering state, the colors shown in box 614 are produced.

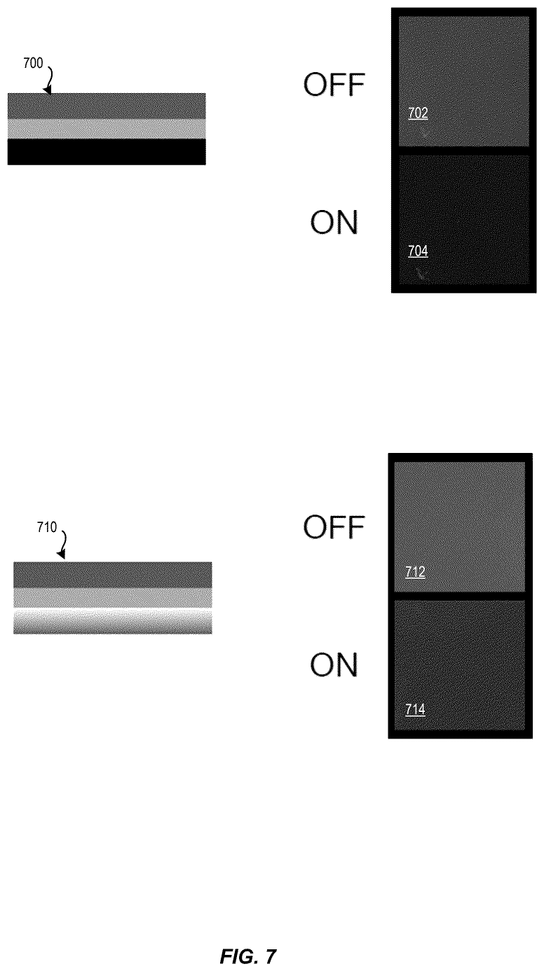

FIG. 7 illustrates details of exemplary bicolor PDLC diffuser structures using color filters in accordance with one or more embodiments. The examples in FIG. 7 depict the results of placing a PDLC diffuser component between color filters and another material of varying types. For example, bicolor PDLC diffuser structure stack configuration 700 includes, from top layer to bottom layer, a color filter (e.g., a red color filter), a PDLC diffuser component, and a black base layer. In one or more embodiments, the color filter can be any color, material, and thickness, while being at least semi-transparent or semi-translucent (e.g., not opaque). Based on whether the PDLC diffuser component of the bicolor PDLC diffuser structure stack configuration 700 is in a light-scattering state or a non-light-scattering state, the bicolor PDLC diffuser structure stack configuration 700 can produce different colors. For example, when the PDLC diffuser component of the bicolor PDLC diffuser structure stack configuration 700 is in a light-scattering state, the color shown in box 702 is produced. When the PDLC diffuser component of the bicolor PDLC diffuser structure stack configuration 700 is in a non-light-scattering state, the color shown in box 704 is produced.

In another example, bicolor PDLC diffuser structure stack configuration 710 includes, from top layer to bottom layer, a color filter (e.g., a red color filter), a PDLC diffuser component, and a mirror base layer. When the PDLC diffuser component of the bicolor PDLC diffuser structure stack configuration 710 is in a light-scattering state, the color shown in box 712 is produced. When the PDLC diffuser component of the bicolor PDLC diffuser structure stack configuration 710 is in a non-light-scattering state, the color shown in box 714 is produced.

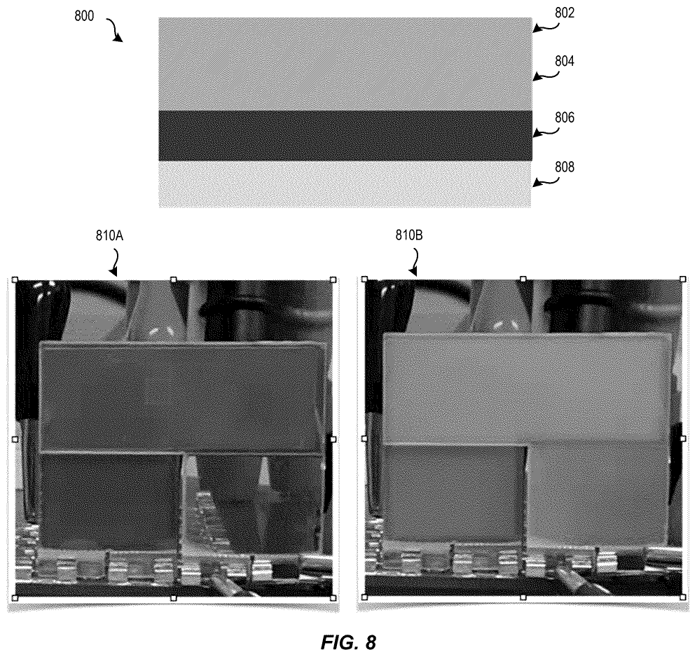

FIG. 8 illustrates details of exemplary bicolor PDLC diffuser structures in accordance with one or more embodiments. In one or more embodiments, bicolor PDLC diffuser structure stack configuration 800 includes, from top layer to bottom layer, two PDLC diffuser components 802 and 804, a color filter 806, and a white base layer 808. In one or more embodiments, the color filter 806 can be any color, material, and thickness, while being at least semi-transparent or semi-translucent (e.g., not opaque). In one or more embodiments, the white base layer 808 can be any material (e.g., plastic, paper, wood, etc.).

Based on whether the PDLC diffuser components 802 and 804 are in a light-scattering state or a non-light-scattering state, the bicolor PDLC diffuser structure stack configuration 800 can produce either a color corresponding to the color filter 806 or a white color. In one or more embodiments, at least two PDLC diffuser components can be layered on top of the color filter and white base layer. In such embodiments, the additional PDLC diffuser component(s) prevent a large amount of the color filter from passing through the PDLC diffuser components.

For example, the top row of example bicolor PDLC diffuser structure 810A illustrates the result of layering two PDLC diffuser components, a purple color filter, a white base layer. In bicolor PDLC diffuser structure 810A, the PDLC diffuser components are in the non-light-scattering state (e.g., transparent or clear), resulting in the purple color from the purple color filter to be seen through the transparent PDLC diffuser components. In bicolor PDLC diffuser structure 810B, the PDLC diffuser components are in the light-scattering state (e.g., white and diffuse), resulting in a white color from the mixture of the two PDLC diffuser components.

The bottom left quadrants of bicolor PDLC diffuser structures 810A and 810B illustrate the result of layering a single PDLC diffuser component, a purple color filter, a white base layer. When the PDLC diffuser component is in the non-light-scattering state, the purple color from the purple color filter can be seen through the transparent PDLC diffuser component with a greater intensity than with the two PDLC diffuser components in the top row. When the PDLC diffuser component is in the light-scattering state, the purple color from the purple color filter can still be seen through the transparent PDLC diffuser component, resulting in a more intense purple color, and not a white color, as compared to the example with the two PDLC diffuser components in the top row.

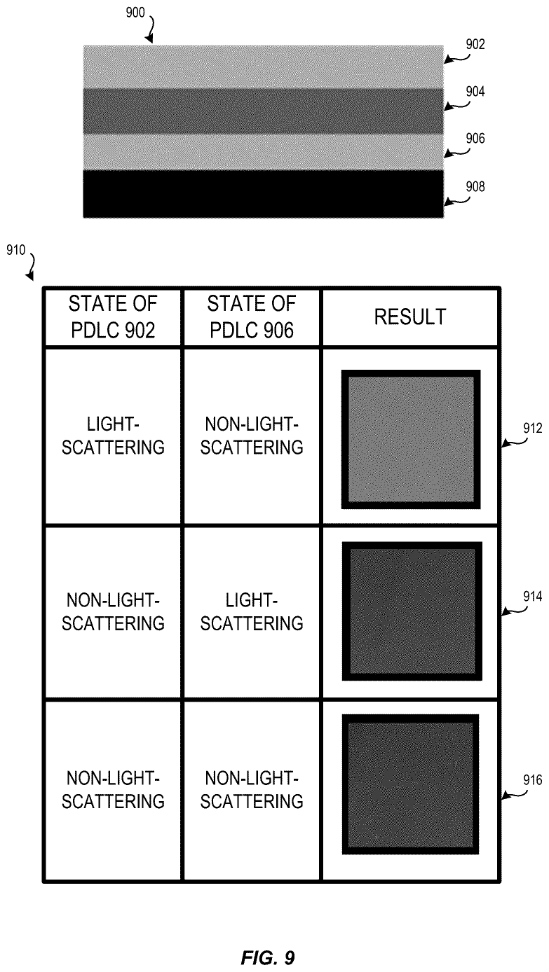

FIG. 9 illustrates details of exemplary tricolor PDLC diffuser structures in accordance with one or more embodiments. In one or more embodiments, tricolor PDLC diffuser structure stack configuration 900 includes, from top layer to bottom layer, a PDLC diffuser component 902, a color filter 904 (e.g., a red color filter), a PDLC diffuser component 906, and a black base layer 908. Based on the independent states of PDLC diffuser component 902 and PDLC diffuser component 906, the tricolor PDLC diffuser structure stack configuration 900 can display multiple different colors, or states, based on the interaction of the color filter 904, the black base layer 908, and the states of PDLC diffuser components 902 and 906. In one or more embodiments, the material for the base layer 908 can include one or more of: a dichroic material (e.g., film, glass, etc.), white paper, black toner printed on white paper, black toner printed on black paper, a neutral density filter, shiny paper (e.g., wrapping paper), foil paper, holographic film, iridescent film, a mirror or mirror film, a polarized filter, a polarized filter stacked with a cross-polarized filter, and any other opaque or semi-opaque materials. In one or more embodiments, the material for the color filter 904 can include one or more of a dichroic material, a neutral density filter, holographic film, iridescent film, a polarized filter, a pair of cross-polarized filters, and any other transparent or semi-transparent materials.

Truth table 910 illustrates the resulting visual output of a tricolor PDLC diffuser structure based on whether PDLC diffuser component 902 and PDLC diffuser component 906 are in a light-scattering state (e.g., white) or a non-light-scattering state (e.g., transparent or clear). Row 912 of truth table 910 shows the resulting visual output of a tricolor PDLC diffuser structure with tricolor PDLC diffuser structure stack configuration 900, when the PDLC diffuser component 902 is in the light-scattering state and the PDLC diffuser component 906 is in the non-light-scattering state. In this example, the resulting visual output of the tricolor PDLC diffuser structure is a color closer to white. Row 914 of truth table 910 shows the resulting visual output of a tricolor PDLC diffuser structure with tricolor PDLC diffuser structure stack configuration 900, when PDLC diffuser component 902 is in the non-light-scattering state, and PDLC diffuser component 906 is in the light-scattering state. In this example, the resulting visual output of the tricolor PDLC diffuser structure is a color closer to the color of color filter 904. Row 916 of truth table 910 shows the resulting visual output of a tricolor PDLC diffuser structure with tricolor PDLC diffuser structure stack configuration 900, when the PDLC diffuser component 902 is in the non-light-scattering state and the PDLC diffuser component 906 is in the non-light-scattering state. In this example, the resulting visual output of the tricolor PDLC diffuser structure is a color closer to black.

In one or more embodiments, the tricolor PDLC diffuser structures can provide a greater range of contrasting colors in comparison to the bicolor PDLC diffuser structures. For example, the range of colors for the tricolor PDLC diffuser structure stack configuration 900 is much greater than the range of colors for the bicolor PDLC diffuser structure stack configuration 700 in FIG. 7. The tricolor PDLC diffuser structure stack configuration 900 can produce colors closer to a contrasting white and a contrasting black based on the states of the two PDLC diffuser components.

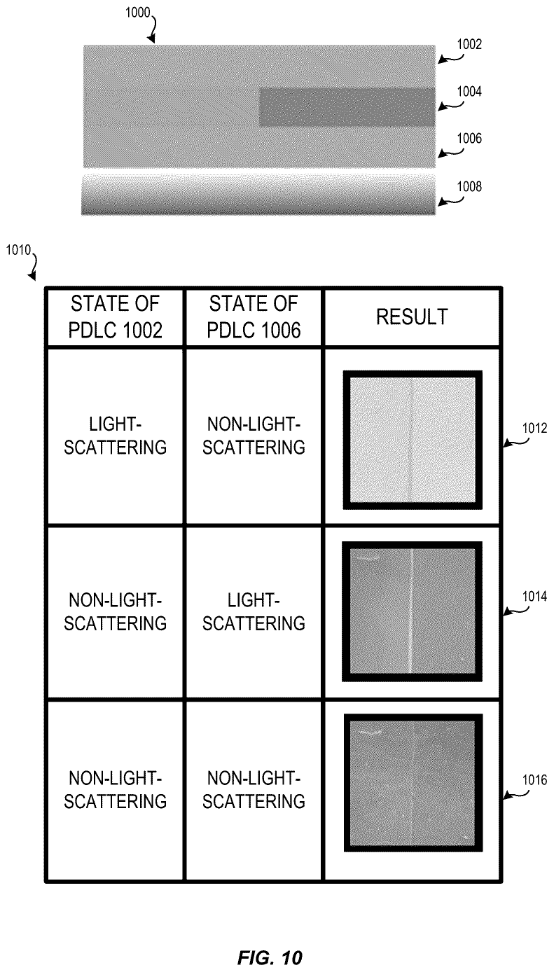

FIG. 10 illustrates details of exemplary tricolor PDLC diffuser structures in accordance with one or more embodiments. In one or more embodiments, tricolor PDLC diffuser structure stack configuration 1000 includes, from top layer to bottom layer, a PDLC diffuser component 1002, dichroic film layer 1004 (e.g., split between cyan and magenta), a PDLC diffuser component 1006, and a mirror base layer 1008. Based on the independent states of PDLC diffuser component 1002 and PDLC diffuser component 1006, the tricolor PDLC diffuser structure stack configuration 1000 can display multiple different colors, or states, based on the interaction of the dichroic film layer 1004, the mirror base layer 1008, and the states of the PDLC diffuser components 1002 and 1006.

Truth table 1010 illustrates the resulting visual output of a tricolor PDLC diffuser structure based on whether PDLC diffuser component 1002 and PDLC diffuser component 1006 are in a light-scattering state (e.g., white) or a non-light-scattering state (e.g., transparent or clear). Row 1012 of truth table 1010 shows the resulting visual output of a tricolor PDLC diffuser structure with tricolor PDLC diffuser structure stack configuration 1000, when PDLC diffuser component 1002 is in the light-scattering state and the PDLC diffuser component 1006 is in the non-light-scattering state. Row 1014 of truth table 1010 shows the resulting visual output of a tricolor PDLC diffuser structure with tricolor PDLC diffuser structure stack configuration 1000, when PDLC diffuser component 1002 is in the non-light-scattering state, and PDLC diffuser component 1006 is in the light-scattering state. Row 1016 of truth table 1010 shows the resulting visual output of a tricolor PDLC diffuser structure with tricolor PDLC diffuser structure stack configuration 1000, when PDLC diffuser component 1002 is in the non-light-scattering state and the PDLC diffuser component 1006 is in the non-light-scattering state.

In one or more embodiments, a texture can be engraved into a color filter or a base layer of another material type. For example, a tricolor PDLC diffuser structure can include, from top to bottom, a first PDLC diffuser component, a filter with a pattern, a second PDLC diffuser component, and a black base layer. In such embodiments, when the first PDLC diffuser component is in the non-light-scattering state and the second PDLC diffuser component is in the light-scattering state, the pattern is visible in the tricolor PDLC diffuser structure. When the first PDLC diffuser component is in the light-scattering state and the second PDLC diffuser component is in the light-scattering state, the tricolor PDLC diffuser structure will display as white (in favor of the diffused first PDLC diffuser component in the tricolor PDLC diffuser structure)When the first PDLC diffuser component is in the non-light-scattering state and the second PDLC diffuser component is in the non-light-scattering state, the tricolor PDLC diffuser structure will display as black (in favor of the black base layer in the tricolor PDLC diffuser structure).

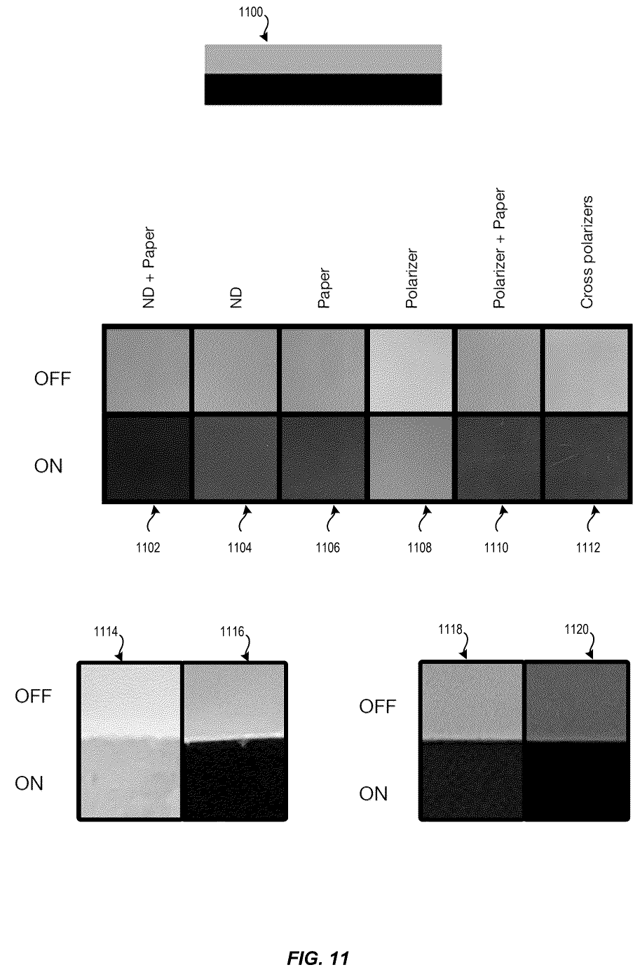

FIG. 11 illustrates details of resulting PDLC diffuser structures under different layer combinations in accordance with one or more embodiments. The examples in FIG. 11 are described with respect to a bicolor PDLC diffuser structure with bicolor PDLC diffuser structure stack configuration 1100. In one or more embodiments, bicolor PDLC diffuser structure stack configuration 1100 includes, from top layer to bottom layer, a PDLC diffuser component and a black base layer. Swatches 1102-1112 each depict results of a bicolor PDLC diffuser structure with a PDLC diffuser component in either a light-scattering state (“OFF”) or a non-light-scattering state (“ON”). Swatch 1102 depicts a base layer that includes a neutral density filter over black paper, swatch 1104 depicts a base layer with a neutral density filter over white paper, swatch 1106 depicts a base layer of only black paper, swatch 1108 depicts a base layer with a single polarizer over white paper, swatch 1110 depicts a base layer that includes a single polarizer over black paper, and swatch 1112 depicts a base layer that includes two cross-polarized filters (one polarized filter orthogonal to another polarized filter) over white paper. In one or more embodiments, the darker the black base layer is, the greater the contrast is between the PDLC diffuser component OFF and ON states.

Swatch 1114 illustrates a bicolor PDLC diffuser structure with, from top to bottom, a PDLC diffuser component and a mirror base layer, with a gray reflection from the environment. When the PDLC diffuser component is in the light-scattering state (“OFF”), the bicolor PDLC diffuser structure will appear as the top box of swatch 1114. When the PDLC diffuser component is in the non-light-scattering state (“ON”), the bicolor PDLC diffuser structure will appear as shown in the bottom box of swatch 1114. In contrast, swatch 1116 illustrates the same bicolor PDLC diffuser structure as swatch 1114, but with a black reflection from the environment. When the PDLC diffuser component is in the light-scattering state (“OFF”), the bicolor PDLC diffuser structure will appear as the top box of swatch 1116. When the PDLC diffuser component is in the non-light-scattering state (“ON”), the bicolor PDLC diffuser structure will appear as the bottom box of swatch 1116.

Swatch 1118 illustrates a bicolor PDLC diffuser structure with, from top to bottom, a PDLC diffuser component and a black paper base layer, with a gray reflection from the environment. When the PDLC diffuser component is in the light-scattering state, the bicolor PDLC diffuser structure will appear as shown on the top box of swatch 1118. When the PDLC diffuser component is in the non-light-scattering state, the bicolor PDLC diffuser structure will appear as shown on the bottom box of swatch 1118. In contrast, swatch 1120 illustrates the same bicolor PDLC diffuser structures as swatch 1118, but with a black reflection from the environment. When the PDLC diffuser component is in the light-scattering state, the bicolor PDLC diffuser structure will appear as shown on the top box of swatch 1120. When the PDLC diffuser component is in the non-light-scattering state, the bicolor PDLC diffuser structure will appear as shown on the bottom box of swatch 1120.

The results from swatches 1114-1120 illustrate the differences in the results based on different environmental conditions (e.g., reflection color) and the type of base layer used (e.g., reflective mirror or non-reflective black paper). For example, in an environment with a gray reflection, there is greater contrast between the light-scattering state and the non-light-scattering state when the base layer is non-reflective compared to the contrast when the base layer is reflective (e.g., a mirror). Conversely, in an environment with a black reflection, there can be greater contrast between the light-scattering state and the non-light-scattering state when the base layer is reflective (e.g., a mirror) compared to the contrast when the base layer is non-reflective.

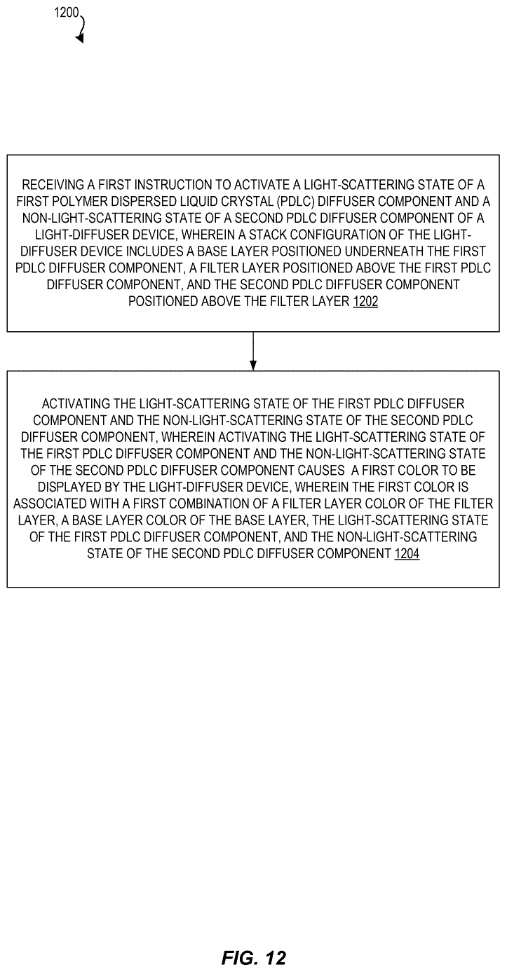

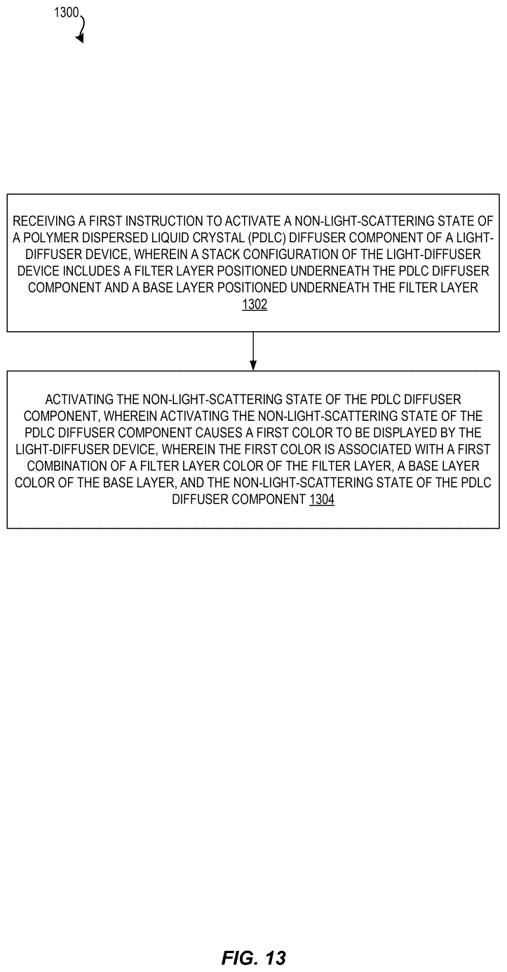

In addition to the foregoing, embodiments can also be described in terms of flowcharts comprising acts and steps in a method for accomplishing a particular result. For example, FIGS. 12 and 13 illustrate flowcharts of exemplary methods in accordance with one or more embodiments. The methods described in relation to FIGS. 12 and 13 may be performed with fewer or more steps/acts or the steps/acts may be performed in differing orders. Additionally, the steps/acts described herein may be repeated or performed in parallel with one another or in parallel with different instances of the same or similar steps/acts.

FIG. 12 illustrates a flowchart of a series of acts in a method of causing the display of multiple colors on a light-diffuser device based on the activation of polymer dispersed liquid crystal (PDLC) diffuser components included in the light-diffuser device. The method 1200 is intended to be illustrative of one or more methods in accordance with the present disclosure and is not intended to limit potential embodiments. Alternative embodiments can include additional, fewer, or different steps than those articulated in FIG. 12.

As illustrated in FIG. 12, the method 1200 includes an act 1202 of receiving a first instruction to activate a light-scattering state of a first polymer dispersed liquid crystal (PDLC) diffuser component and a non-light-scattering state of a second PDLC diffuser component of a light-diffuser device, wherein a stack configuration of the light-diffuser device includes a base layer positioned underneath the first PDLC diffuser component, a filter layer positioned above the first PDLC diffuser component, and the second PDLC diffuser component positioned above the filter layer. In one or more embodiments, the material for the base layer can be one or more of: a dichroic material (e.g., film, glass, etc.), white paper, black toner printed on white paper, black toner printed on black paper, a neutral density filter, holographic film, iridescent film, a mirror, a polarized filter, a polarized filter stacked with a cross-polarized filter, and any other opaque or semi-opaque materials. In one or more embodiments, the material for the filter layer can include one or more of a dichroic material, a neutral density filter, holographic film, iridescent film, a polarized filter, a pair of cross-polarized filters, and any other transparent or semi-transparent materials.

As illustrated in FIG. 12, the method 1200 includes an act 1204 of activating the light-scattering state of the first PDLC diffuser component and the non-light-scattering state of the second PDLC diffuser component, wherein activating the light-scattering state of the first PDLC diffuser component and the non-light-scattering state of the second PDLC diffuser component causes a first color to be displayed by the light-diffuser device, wherein the first color is associated with a first combination of a filter layer color of the filter layer, a base layer color of the base layer, the light-scattering state of the first PDLC diffuser component, and the non-light-scattering state of the second PDLC diffuser component. When in the light-scattering state, the PDLC diffuser components can appear white, milky, or otherwise opaque. When the light-scattering state of a PDLC diffuser component is activated, layers beneath the corresponding PDLC diffuser component can be partially obscured by the opaqueness of the PDLC diffuser component. When in the non-light-scattering state, the PDLC diffuser components can appear transparent or clear and layers beneath the corresponding PDLC diffuser component can be more easily seen through the transparency of the PDLC diffuser component. Based on the stack configuration, the first color will be a combination, or mixture, of the base layer color and the filter layer color as seen through the first PDLC diffuser component in the light-scattering state and the second PDLC diffuser component in the non-light-scattering state.

In one or more embodiments, a second instruction to activate the non-light-scattering state of the first PDLC diffuser component of the light-diffuser device is received. In response to the receiving the second instruction, the non-light-scattering state of the first PDLC diffuser component is activated, while the second PDLC diffuser component remains in the non-light-scattering state. In such embodiments, activating the non-light-scattering state of the first PDLC diffuser component causes a second color to be displayed by the light-diffuser device, where the second color is associated with a second combination of the filter layer color, the base layer color, the non-light-scattering state of the first PDLC diffuser component, and the non-light-scattering state of the second PDLC diffuser component. Based on the stack configuration, the second color will be a combination, or mixture, of the base layer color and the filter layer color as seen through the first PDLC diffuser component in the non-light-scattering state and the second PDLC diffuser component in the non-light-scattering state.

In one or more embodiments, a third instruction to activate the light-scattering state of the second PDLC diffuser component of the light-diffuser device is received. In response to the receiving the third instruction, the light-scattering state of the second PDLC diffuser component is activated, while the first PDLC diffuser component remains in the non-light-scattering state. In such embodiments, activating the light-scattering state of the second PDLC diffuser component causes a third color to be displayed by the light-diffuser device, where the third color is associated with a third combination of the filter layer color, the base layer color, the non-light-scattering state of the first PDLC diffuser component, and the light-scattering state of the second PDLC diffuser component. Based on the stack configuration, the third color will be a combination, or mixture, of the base layer color and the filter layer color as seen through the first PDLC diffuser component in the non-light-scattering state and the second PDLC diffuser component in the light-scattering state.

In some embodiments, the second PDLC diffuser component and the filter layer are separated by a gap (e.g., a physical separation). In such embodiments, where the filter layer is a holographic film, the gap can allow for increased visibility of the colors of the holographic film. In contrast, when the second PDLC diffuser component and the holographic film layer are in direct contact (e.g., there is no gap), the second PDLC diffuser component can attenuate the light, preventing the colors of the holographic film from being seen.

In other embodiments, where the filter layer has a textured pattern (e.g., engraved into the filter layer), when the first PDLC diffuser component is in the light-scattering state and the second PDLC diffuser component is in the non-light-scattering state, a gap between the second PDLC diffuser component and the filter layer can allow for greater visibility of the textured pattern in comparison to when there is no gap between the second PDLC diffuser component and the filter layer.

In one or more embodiments, the filter layer is a dichroic film and the base layer is a mirror film. In such embodiments, when the first PDLC diffuser component and the second PDLC diffuser component are in the non-light-scattering state, the filter layer can appear transparent and the color displayed by the light-diffuser device is associated with the combination of a color of the transparent filter layer and a color of the reflection of the mirror film, as seen through the first PDLC diffuser component and the second PDLC diffuser component in the non-light-scattering state.

In one or more embodiments, the one or both of the first and second PDLC diffuser components can be partially transitioned between the non-light-scattering state and the light-scattering state, or vice versa. In such embodiments, different amounts of voltages can be applied to a PDLC diffuser component to achieve different grayscale or transparency levels for the PDLC diffuser component.

FIG. 13 illustrates a flowchart of a series of acts in a method of causing the display of multiple colors on a light-diffuser device based on the activation of a polymer dispersed liquid crystal (PDLC) diffuser component included in the light-diffuser device. The method 1300 is intended to be illustrative of one or more methods in accordance with the present disclosure and is not intended to limit potential embodiments. Alternative embodiments can include additional, fewer, or different steps than those articulated in FIG. 13.

As illustrated in FIG. 13, the method 1300 includes an act 1302 of receiving a first instruction to activate a non-light-scattering state of a polymer dispersed liquid crystal (PDLC) diffuser component of a light-diffuser device, wherein a stack configuration of the light-diffuser device includes a filter layer positioned underneath the PDLC diffuser component and a base layer positioned underneath the filter layer. In one or more embodiments, the material for the base layer can be one or more of: a dichroic material (e.g., film, glass, etc.), white paper, black toner printed on white paper, black toner printed on black paper, a neutral density filter, holographic film, iridescent film, a mirror, a polarized filter, a polarized filter stacked with a cross-polarized filter, and any other opaque or semi-opaque materials. In one or more embodiments, the material for the filter layer can include one or more of a dichroic material, a neutral density filter, holographic film, iridescent film, a polarized filter, a pair of cross-polarized filters, and any other transparent or semi-transparent materials.

As illustrated in FIG. 13, the method 1300 includes an act 1304 of activating the non-light-scattering state of the PDLC diffuser component, wherein activating the non-light-scattering state of the PDLC diffuser component causes a first color to be displayed by the light-diffuser device, wherein the first color is associated with a first combination of a filter layer color of the filter layer, a base layer color of the base layer, and the non-light-scattering state of the PDLC diffuser component. When in the light-scattering state, the PDLC diffuser component can appear white, milky, or otherwise opaque. When the light-scattering state of a PDLC diffuser component is activated, layers beneath the corresponding PDLC diffuser component can be obscured, or partially obscured, by the opaqueness of the PDLC diffuser component. In one or more embodiments, colors of the filter layer and the base layer combine with the color of the PDLC diffuser component in the light-scattering state to produce a blended color. When in the non-light-scattering state, the PDLC diffuser component can appear transparent or clear and layers beneath the corresponding PDLC diffuser component can be more easily seen through the transparency of the PDLC diffuser component. Based on the stack configuration, the first color will be a combination, or mixture, of the base layer color and the filter layer color as seen through the PDLC diffuser component in the non-light-scattering state.

In one or more embodiments, a second instruction to activate the light-scattering state of the PDLC diffuser component of the light-diffuser device is received. In response to the receiving the second instruction, the light-scattering state of the PDLC diffuser component is activated. In such embodiments, activating the light-scattering state of the PDLC diffuser component results in the PDLC diffuser component appearing white, milky, or otherwise opaque. When the light-scattering state of the PDLC diffuser component is activated, layers beneath the PDLC diffuser component can be partially obscured by the opaqueness of the PDLC diffuser component. As a result, this causes a second color to be displayed by the light-diffuser device, where the second color is associated with a second combination of the filter layer color, the base layer color, and the light-scattering state of the PDLC diffuser component.

In one or more embodiments, the PDLC diffuser component can be partially transitioned between the non-light-scattering state and the light-scattering state. In such embodiments, different amounts of voltages can be applied to the PDLC diffuser component to achieve different grayscale or transparency levels for the PDLC diffuser component.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

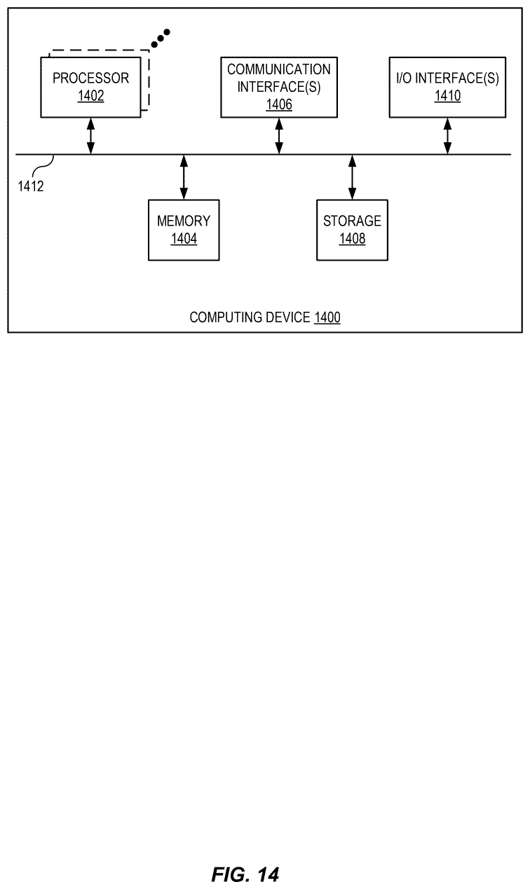

FIG. 14 illustrates, in block diagram form, an exemplary computing device 1400 that may be configured to perform one or more of the processes described above. As shown by FIG. 14, the computing device can comprise a processor 1402, memory 1404, one or more communication interfaces 1406, a storage device 1408, and one or more I/O devices/interfaces 1410. In certain embodiments, the computing device 1400 can include fewer or more components than those shown in FIG. 14. Components of computing device 1400 shown in FIG. 14 will now be described in additional detail.

In particular embodiments, processor(s) 1402 includes hardware for executing instructions, such as those making up a computer program. As an example, and not by way of limitation, to execute instructions, processor(s) 1402 may retrieve (or fetch) the instructions from an internal register, an internal cache, memory 1404, or a storage device 1408 and decode and execute them. In various embodiments, the processor(s) 1402 may include one or more central processing units (CPUs), graphics processing units (GPUs), field programmable gate arrays (FPGAs), systems on chip (SoC), or other processor(s) or combinations of processors.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1404 may be internal or distributed memory.

The computing device 1400 can further include one or more communication interfaces 1406. A communication interface 1406 can include hardware, software, or both. The communication interface 1406 can provide one or more interfaces for communication (such as, for example, packet-based communication) between the computing device and one or more other computing devices 1400 or one or more networks. As an example, and not by way of limitation, communication interface 1406 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can comprise hardware, software, or both that couples components of computing device 1400 to each other.

The computing device 1400 includes a storage device 1408 includes storage for storing data or instructions. As an example, and not by way of limitation, storage device 1408 can comprise a non-transitory storage medium described above. The storage device 1408 may include a hard disk drive (HDD), flash memory, a Universal Serial Bus (USB) drive or a combination these or other storage devices. The computing device 1400 also includes one or more input or output (“I/O”) devices/interfaces 1410, which are provided to allow a user to provide input to (such as user strokes), receive output from, and otherwise transfer data to and from the computing device 1400. These I/O devices/interfaces 1410 may include a mouse, keypad or a keyboard, a touch screen, camera, optical scanner, network interface, modem, other known I/O devices or a combination of such I/O devices/interfaces 1410. The touch screen may be activated with a stylus or a finger.

The I/O devices/interfaces 1410 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1410 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A light-diffuser device comprising:
a base layer positioned underneath a first polymer dispersed liquid crystal (PDLC) diffuser component;
a filter layer positioned above the first PDLC diffuser component; and
a second PDLC diffuser component positioned above the filter layer.

2. The light-diffuser device of claim 1, wherein a combination of the filter layer and the base layer is visible when the first PDLC diffuser component and the second PDLC diffuser component are in a non-light-scattering state.

3. The light-diffuser device of claim 1, wherein the filter layer is visible when the first PDLC diffuser component is in a light-scattering state and the second PDLC diffuser component is in a non-light-scattering state.

4. The light-diffuser device of claim 1, wherein the filter layer and the base layer are obscured when the first PDLC diffuser component is in a non-light-scattering state and the second PDLC diffuser component is in a light-scattering state.

5. The light-diffuser device of claim 1, wherein the filter layer includes a pattern, and wherein the pattern is visible when the first PDLC diffuser component is in a light-scattering state and the second PDLC diffuser component is in a non-light-scattering state.

6. The light-diffuser device of claim 1, wherein the base layer includes one or more of: a dichroic material, white paper, black toner printed on white paper, black toner printed on black paper, a neutral density filter, holographic film, iridescent film, a mirror, a polarized filter, and a pair of cross-polarized filters.

7. The light-diffuser device of claim 1, wherein the filter layer includes one or more of: a dichroic material, a neutral density filter, holographic film, iridescent film, a polarized filter, and a pair of cross-polarized filters.

8. A method comprising:
receiving a first instruction to activate a light-scattering state of a first polymer dispersed liquid crystal (PDLC) diffuser component and a non-light-scattering state of a second PDLC diffuser component of a light-diffuser device, wherein a stack configuration of the light-diffuser device includes a base layer positioned underneath the first PDLC diffuser component, a filter layer positioned above the first PDLC diffuser component, and the second PDLC diffuser component positioned above the filter layer; and
activating the light-scattering state of the first PDLC diffuser component and the non-light-scattering state of the second PDLC diffuser component, wherein activating the light-scattering state of the first PDLC diffuser component and the non-light-scattering state of the second PDLC diffuser component causes a first color to be displayed by the light-diffuser device, wherein the first color is associated with a first combination of a filter layer color of the filter layer, a base layer color of the base layer, the light-scattering state of the first PDLC diffuser component, and the non-light-scattering state of the second PDLC diffuser component.

9. The method of claim 8, wherein the filter layer color includes a textured pattern visible when the first PDLC diffuser component is in the light-scattering state, the second PDLC diffuser component is in the non-light-scattering state, and the second PDLC diffuser component and the filter layer are separated by a gap.

10. The method of claim 8, further comprising:
receiving a second instruction to activate the non-light-scattering state of the first PDLC diffuser component of the light-diffuser device; and
activating the non-light-scattering state of the first PDLC diffuser component, wherein activating the non-light-scattering state of the first PDLC diffuser component causes a second color to be displayed by the light-diffuser device, wherein the second color is associated with a second combination of the filter layer color, the base layer color, the non-light-scattering state of the first PDLC diffuser component, and the non-light-scattering state of the second PDLC diffuser component.

11. The method of claim 10, wherein activating the non-light-scattering state of the first PDLC diffuser component further comprises:
partially transitioning the first PDLC diffuser component from the light-scattering state to the non-light-scattering state based on a voltage applied to the first PDLC diffuser component.

12. The method of claim 10, further comprising:
receiving a third instruction to activate the light-scattering state of the second PDLC diffuser component of the light-diffuser device; and
activating the light-scattering state of the second PDLC diffuser component, wherein activating the light-scattering state of the second PDLC diffuser component causes a third color to be displayed by the light-diffuser device, wherein the third color is associated with a third combination of the filter layer color, the base layer color, the non-light-scattering state of the first PDLC diffuser component, and the light-scattering state of the second PDLC diffuser component.

13. The method of claim 8, further comprising:
receiving a second instruction to activate the non-light-scattering state of the first PDLC diffuser component of the light-diffuser device; and
activating the non-light-scattering state of the first PDLC diffuser component causes a second color to be displayed by the light-diffuser device, wherein the filter layer is a dichroic film and the base layer is a mirror film, and wherein when the first PDLC diffuser component and the second PDLC diffuser component are in the non-light-scattering state, the filter layer appears transparent and the second color is associated with a second combination of a transparent filter layer color of the transparent filter layer and a reflected color of the mirror film.

14. The method of claim 8, wherein the base layer includes one or more of: a dichroic material, white paper, black toner printed on white paper, black toner printed on black paper, a neutral density filter, holographic film, iridescent film, a mirror, a polarized filter, and a pair of cross-polarized filters, and wherein the filter layer includes one or more of: a dichroic material, a neutral density filter, holographic film, iridescent film, a polarized filter, and a pair of cross-polarized filters.

15. A method comprising:
receiving a first instruction to activate a non-light-scattering state of a polymer dispersed liquid crystal (PDLC) diffuser component of a light-diffuser device, wherein a stack configuration of the light-diffuser device includes a filter layer positioned underneath the PDLC diffuser component and a base layer positioned underneath the filter layer; and
activating the non-light-scattering state of the PDLC diffuser component, wherein activating the non-light-scattering state of the PDLC diffuser component causes a first color to be displayed by the light-diffuser device, wherein the first color is associated with a first combination of a filter layer color of the filter layer, a base layer color of the base layer, and the non-light-scattering state of the PDLC diffuser component.

16. The method of claim 15, further comprising:
receiving a second instruction to activate a light-scattering state of the PDLC diffuser component of the light-diffuser device; and
activating the light-scattering state of the PDLC diffuser component, wherein activating the non-light-scattering state of the PDLC diffuser component causes a second color to be displayed by the light-diffuser device, wherein the second color is associated with a second combination of the filter layer color, the base layer color, and the light-scattering state of the PDLC diffuser component.

17. The method of claim 16, wherein the filter layer color of the filter layer includes a textured pattern visible when the PDLC diffuser component is in the non-light-scattering state and the PDLC diffuser component and the filter layer are separated by a gap.

18. The method of claim 16, wherein activating the light-scattering state of the PDLC diffuser component further comprises:
partially transitioning the PDLC diffuser component from a non-light-scattering state to the light-scattering state based on a voltage applied to the PDLC diffuser component.

19. The method of claim 15, wherein the base layer includes one or more of: a dichroic material, white paper, black toner printed on white paper, black toner printed on black paper, a neutral density filter, holographic film, iridescent film, a mirror, a polarized filter, and a pair of cross-polarized filters.

20. The method of claim 15, wherein the filter layer includes one or more of: a dichroic material, a neutral density filter, holographic film, iridescent film, a polarized filter, and a pair of cross-polarized filters.
